(19) United States
(12) Patent Application Publication
(10) Pub. No.: US 2003/0091418 A1
(43) Pub. Date: May 15, 2003

(54) Lifting systems for use with vehicles

(75) Inventors: James Patterson Ranken, Elaine (AU); Richard John Lyons, Invermay (AU); Mark Raymond Thomas, Beaufort (AU)

Correspondence Address: SEED INTELLECTUAL PROPERTY LAW GROUP PLLC, 701 FIFTH AVE, SUITE 6300, SEATTLE, WA, 98104-7092, US

(73) Assignee: Ranken Research Pty. Ltd., Geelong (AU)

(21) Appl. No.: 10/279,083

(22) Filed: Oct. 22, 2002

(30) Foreign Application Priority Data
Oct. 22, 2001 (AU) PR8406/01

(51) Int. Cl. B60P 1/00

(52) U.S. Cl. 414/545

(57) ABSTRACT

A lifting system is attached to the rear of a pick-up truck and has a load carrying platform which can be raised and lowered between the tray of the truck and the ground to assist loading and unloading. The platform is raised and lowered by operation of a cable system incorporated within a frame. The frame and platform structure can be pivoted to a stowed position in which the platform structure then acts as a tailgate for the vehicle. The frame and the platform structure are foldable to a reduced depth configuration so that when in the stowed configuration the height of the frame and platform structure then approximates to the height of the sides of the truck.

### BACKGROUND OF THE INVENTION

1) Field of the Invention

The present invention relates to lifting systems for use with vehicles and more particularly to a lifting system comprising a lifting platform associated with a tray of a load-carrying vehicle to facilitate loading and unloading of the tray.

2) Description of the Prior Art

In our U.S. Pat. No. 6,059,527 the disclosure of which is hereby incorporated by reference, there is disclosed a rear loading system for vehicles comprising a load-carrying platform raised from the ground by lifting cables to a position level with the tray of the vehicle. The cables are mounted in a U-shaped support frame attached to the rear of the vehicle and the platform is raised and lowered relative to the support frame by operating a winding mechanism associated with the cables. When level with the U-shaped frame, the platform can be locked thereto and frame and platform can be pivoted to a vertical position to act as a tail gate for the vehicle.

In this prior system, the overall height of the structure when the U-shaped frame and platform are pivoted to a vertical position to act as a tail gate corresponds to the length of the opposed arms of the U-shaped frame. For some types of pick-up truck with relatively low sides, as are commonly available in the USA, there will be significant projection of the structure above the level of the side walls and this can detract from the appearance of the vehicle and also impede vision and access. Likewise, when the structure is pivoted to a horizontal position when the structure is being used as a conventional tail gate rather than when used in its lifting mode, the substantial horizontal projection of the U-shaped frame can also impede access.

### SUMMARY OF THE INVENTION

According to the invention there is provided a lifting system for attachment to a vehicle having a load-carrying tray, said system comprising support structure arranged for attachment to the vehicle, means for mounting the support structure for pivotal movement between an operative position in which the structure extends outwardly relative to the tray and a stowed position in which the structure extends substantially vertically relative to the tray, a load-carrying platform structure suspended from the support structure by several flexible elements, and drive means for extending and retracting the flexible elements relative to the support structure so as to raise and lower the platform structure vertically relative to the support structure between a position in which the platform structure is adjacent the tray and a position in which the platform structure is adjacent the ground, the flexible elements maintaining the platform structure in a substantially horizontal orientation during its vertical movement, wherein the support structure is capable of alteration into a reduced-length configuration to reduce the height of the support structure when in said stowed position, and the platform structure is capable of alteration into a configuration of reduced depth whereby to be of reduced height when in said stowed position.

Further according to the invention there is provided a lifting system for attachment to a vehicle having a load-carrying tray, said system comprising a support frame arranged for attachment to the vehicle, said support frame comprising opposed longitudinal frame members interconnected at their inner ends by a transverse frame member adapted to lie adjacent the vehicle tray whereby the frame is of generally U-shape open at an outer side, means for mounting the frame for pivotal movement of the frame about a generally horizontal axis parallel to the transverse frame member such that the frame is pivotal between an operative position in which the frame extends substantially horizontally outwardly relative to the tray and a stowed position in which the frame extends substantially vertically relative to the tray, a load-carrying platform structure suspended from the support frame by several flexible elements, and drive means for extending and retracting the flexible elements relative to the support frame so as to raise and lower the platform structure vertically relative to the frame between a position in which the platform structure is adjacent the tray and a position in which the platform structure is adjacent the ground, the flexible elements maintaining the platform structure in a substantially horizontal orientation during its vertical movement, wherein the opposed longitudinal frame members of the frame are capable of alteration into a reduced-length configuration to reduce the height of the frame when in said stowed position, and the platform structure is capable of alteration into a configuration of reduced depth whereby to be of reduced height when in said stowed position.

The altered configuration of the frame and platform structure in the stowage position enables the assembly to form in that position a tail gate of reduced height approximating to that of the sides of a pick-up truck even when the truck has relatively low sides.

Advantageously, each of the opposed longitudinal frame members is of articulated structure such that alteration to the reduced length configuration is effected by pivoting an outer part of the frame member to a retracted position in which it extends substantially perpendicularly to an inner part of the frame member. Preferably, at least some of the flexible elements pass along the longitudinal frame members and the tension in these elements in the operative condition of the lifting system acts to maintain the outer part of the frame member in its extended operative configuration, thereby preventing unintentional pivotal movement into the retracted position.

Advantageously, reduction in the depth of the platform structure is achieved by forming die platform structure with an outer platform segment which is able to be pivoted over an inner platform segment prior to movement into the stowed position. With this configuration, when the outer platform segment has been pivoted over the inner platform segment, the outer parts of the two longitudinal frame members can be pivoted substantially through 90° inwardly to lie adjacent the transverse edges of the inner and outer platform segments.

### BRIEF DESCRIPTION OF THE DRAWINGS

An embodiment of the invention will now be described by way of example only with reference to the accompanying drawings in which:

FIG. 1 is a schematic view showing part of a lifting system in accordance with the preferred embodiment of the invention, certain of the external structure being shown in phantom line in order to better illustrate the detailed structure;

FIGS. 2a to 2e show sequential stages in the conversion of the lifting system into a tail gate of reduced height;

FIG. 3 shows schematically a pivotal joint between inner and outer parts of a main support frame of the lifting system; and

FIG. 4 is an exploded view showing the principal components of the joint of FIG. 3.

### DESCRIPTION OF THE PREFERRED EMBODIMENTS

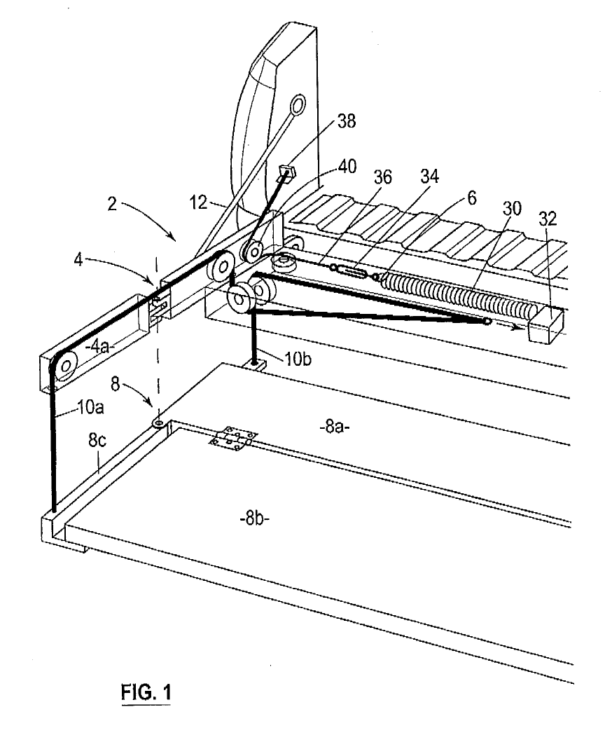

The basic principles of construction and operation of the lifting system of the preferred embodiment of the invention are the same as that disclosed in our U.S. Pat. No. 6,059,527 to which detailed reference may be made. As such, the system comprises a U-shaped main support frame 2 mounted at the rear of the vehicle and having opposed longitudinally extending frame members or arms 4 connected by a transverse member 6 adjacent the vehicle tray. A load-carrying platform 8 is suspended from the frame 2 via cables 10a-10d or other flexible elements and which car, be extended and retracted relative to the frame 2 as described in U.S. Pat. No. 6,059,527 so as to raise and lower the platform 8 between the level of the vehicle tray and ground level. Specifically, the cables 10a-10d extend via the longitudinal arms 4 into the transverse frame member 6 and are either coupled to an endless driven chain or belt within the transverse frame member 6 as disclosed in our prior US patent or pass via the transverse frame member 6 onto a winch drum or the like. It is to be noted that the transverse member 6 is somewhat wider than that illustrated in our prior US patent and this increased width enables the platform 8 to extend clear of a bumper bar at the rear of the vehicle. The frame 2 with the platform 8 attached thereto is pivotal between the operative horizontal position shown in FIG. 1 in which it is retained by stays 12 and ant inoperative stowed position to act as a tail gate for the vehicle.

In contrast to the structure disclosed in our prior US patent, the opposed longitudinal arms 4 of the U-shaped frame 2 are of articulated construction to provide a pivotal outer part 4a which is foldable inwardly to provide a reduced length configuration when in an inoperative/stowage mode. Similarly, the load-carrying platform 8 has a structure which enables it to be folded into a reduced depth/height configuration. The platform structure comprises an inner segment consisting of load-carrying surface 8a and associated supporting frame to which lifting cables lob, 10d are attached, and an outer segment consisting of a load-carrying surface 8b hinged to the outer edge of the load-carrying surface 8a of the inner segment so as to be foldable over that surface in storage mode, and opposed supporting arms 8c to which lifting cables 10a, 10c are attached. The arms 8c are hinged to the inner segment so as to be foldable inwardly in the stowage mode. In this way, when the lifting system is in an inoperative mode and is simply acting as a tail gate for the vehicle, the overall height of the tail gate thus formed can correspond to the height of even relatively low side walls of the vehicle in order to give the appearance similar to that of a substantially conventional tail gate. Likewise, when the tail gate is opened in this mode, its outward projection from the vehicle tray will approximate to that of a standard tail gate for the vehicle and will therefore not provide any increased impediment to access.

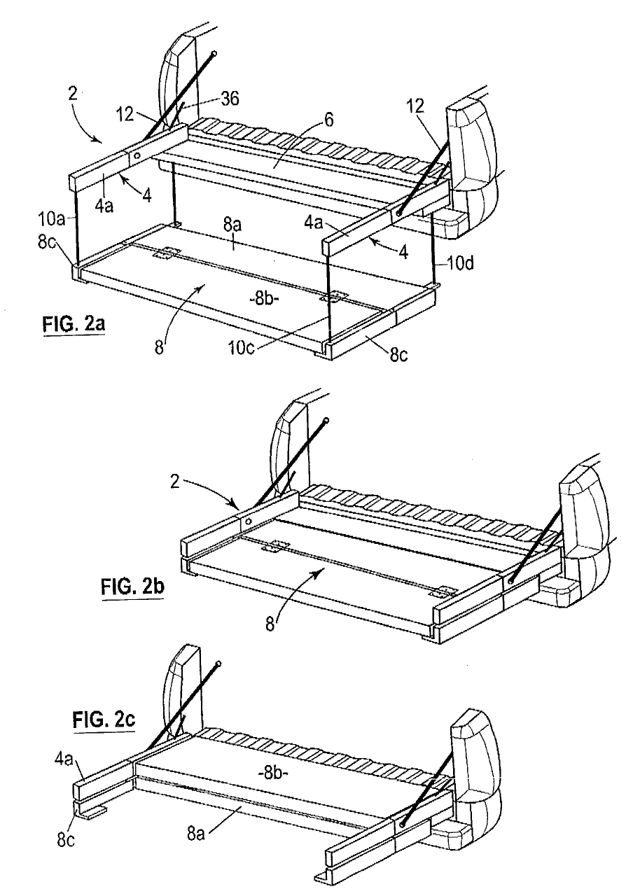

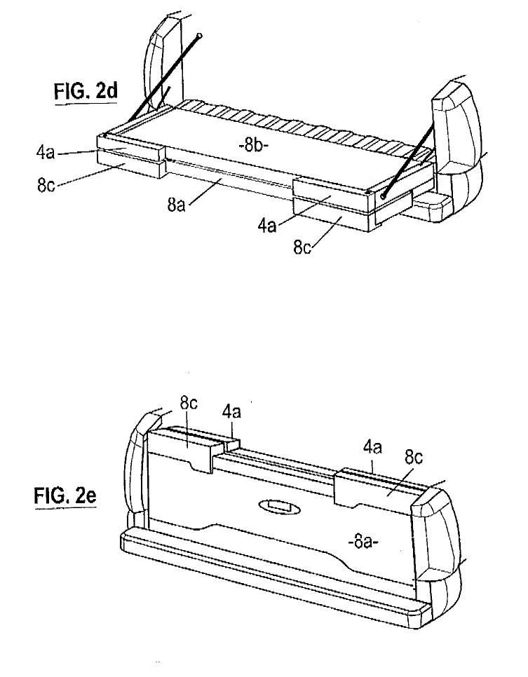

FIG. 2a shows the lifting system schematically in its operative condition with the platform 8 at ground level and FIG. 2b shows the platform 8 raised to the level of the frame 2 and the vehicle tray; in this position to facilitate stowage, the platform 8 can be locked to the frame 2 by suitable catches acting between inner platform segment 8a and the inner parts of the arms 4. FIG. 2c shows the outer segment 8b of the platform folded into its stowage position on top of the inner platform segment 8a at the start of the stowage operation and locked thereto by suitable catches. To finalise stowage, the outer parts 4a of the arms 4, and the arms 8c are folded inwardly as shown in FIG. 2d. The structure can then be pivoted upwardly as shown in FIG. 2e to form a tail gate corresponding in height to the side walls of the vehicle, the tail gate being locked in closed position by suitable catches.

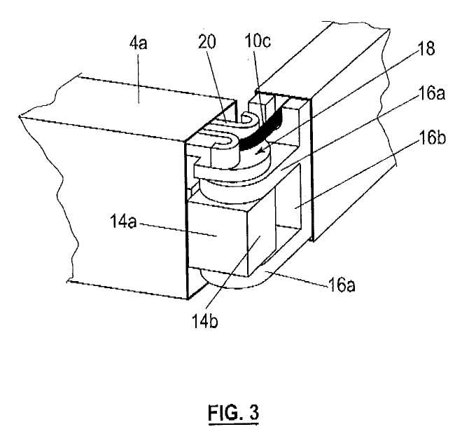

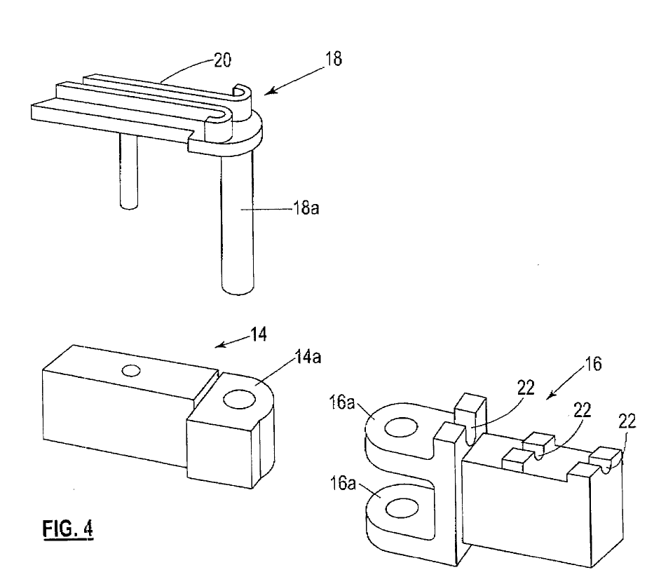

FIGS. 3 and 4 show an embodiment of a suitable pivot joint for the outer parts 4a of the opposed arms 4 of the U-shaped frame 2. As shown, the joint comprises outer and inner components 14, 16 mounted within the interior of the outer and inner parts of the arm 4 and comprising cooperating pivot eyes 14a, 16a, and a linking component 18 comprising a pivot pin 18a engageable through the cooperating eyes 14a, 16a. The linking component 18 fits on top of the outer component 14 to form an assembly lying within the outer pivotal part 4a of the arm. The body of the linking component 18 includes a cable guide 20 to guide the respective cable 10a or 10c during the 90° rotation of the joint so as to maintain a substantially constant cable tension. Although the cable tension is maintained substantially constant during the pivotal movement of the joint, it may be desirable to configure the cable guide so that during the pivotal movement between the extended and folded position there is a slight increase in cable tension at an intermediate position so as to provide an over-centre action whereby the cable tension will act in a sense to maintain the outer part 4a of the arm in its extended and folded conditions. In the extended position, opposing joint faces 14b, 16b are in engagement in order to prevent further outwards rotation beyond that position. The upper surface of the joint component 16 mounted in the inner part of the arm 4 is also formed with cable guides 22. It is to be noted that in the operative mode of the lifting system, the cable guides 20 and 22 ensure that the cable is maintained to extend longitudinally of the arm 4 whereby the cable tension will itself act to prevent folding of the outer part 4a of the arm. The outer joint component 14 is configured so as to be reversible so that an identical component can be fitted at each side of the frame 4 so as to permit the 90° pivotal movement of both left and right hand arm parts 4a in an inwards direction. It is to be understood that the joint structure particularly described is an example of a number of alternative forms of joint which could be incorporated for the purpose described.

The facility to fold the lifting system including frame 2 and platform 8 into the reduced height configuration for stowage may mean that in its unfolded operative position the area of the platform 8 is able to be somewhat larger than is practical in the lifting system described in U.S. Pat. No. 6,059,527. While this is advantageous, nevertheless it can result in the overall structure being somewhat heavier thereby requiring greater force to lift it into its stowed position. Preferably, to facilitate lifting a tension spring 30 is mounted in the transverse frame member 6. One end of the spring 30 is connected to a fixed support 32 and the other end of the spring is linked via a turnbuckle 34 for adjusting spring tension, to a cable 36 which extends via the interior of the inner part of the adjacent arm 4 to a fixed mounting 38, the cable 36 being guided by pulleys including a pulley 40 concealed within the inner part of the arm 4. In the operative position of the frame 2, the cable 36 places the spring 30 under increased tension and this increased tension results in the cable 36 applying via the pulley 40 an upwards force to the arm 4. Although this upwards force is insufficient in itself to pivot the frame 2 and platform 8 upwardly, nevertheless it will act to reduce the manual force needed to be applied to the structure to pivot it into its stowed position. A second like spring and cable arrangement is incorporated within the transverse frame member 6 at the other side of the mounting 32 for cooperation with the opposite arm 4.

In the preferred embodiment described in U.S. Pat. No. 6,059,527, extension and retraction of the cables is effected by driving the endless chain or belt within the transverse frame member of the U-shaped frame via a drive shaft extending through one of the opposed arms of the frame. However, due to the articulated construction of the arms in this embodiment of the present invention, a drive shaft extending through the entire length of one of the arms 4 is not feasible, but as will be appreciated a simple drive mechanism extending through just the inner part of the arm and actuated by a removable handle at the side of that inner arm part could alternatively be used to drive the endless chain or belt as could a drive shaft extending into the transverse frame member 6 and operated by a handle externally of that frame member. In practice, however, it is likely that the preferred option would be a powered drive using an electric motor driving the endless chain or belt. The increased width of the frame member 6 incorporated for the reason previously described will also provide increased interior space within the frame member 6 to house the motor and associated drive-transmitting components. Alternatively the cables could pass via the frame 4 to a winch mechanism mounted in a convenient position externally of the frame and accessible for manual or powered operation.

The embodiment has been described by way of example only and modifications are possible within the scope and spirit of the invention.

We claim:

1. A lifting system for attachment to a vehicle having a load-carrying tray, said system comprising support structure arranged for attachment to the vehicle, the support structure being mounted for pivotal movement between an operative position in which the structure extends outwardly relative to the tray and a stowed position in which the structure extends substantially vertically relative to the tray, a load-carrying platform structure suspended from the support structure by several flexible elements, and a drive system for extending and retracting the flexible elements relative to the support structure so as to raise and lower the platform structure vertically relative to the support structure between a position in which the platform structure is adjacent the tray and a position in which the platform structure is adjacent the ground, the flexible elements maintaining the platform structure in a substantially horizontal orientation during its vertical movement, wherein the support structure is capable of alteration into a reduced-length configuration to reduce the height of the support structure when in said stowed position, and the platform structure is capable of alteration into a configuration of reduced depth whereby to be of reduced height when in said stowed position.

2. A lifting system for attachment to a vehicle having a load-carrying tray, said system comprising a support frame arranged for attachment to the vehicle, said support frame comprising opposed longitudinal frame members interconnected at their inner ends by a transverse frame member adapted to lie adjacent the vehicle tray whereby the frame is of generally U-shape open at an outer side, the flame being mounted for pivotal movement about a generally horizontal axis parallel to the transverse frame member such that the frame is pivotal between an operative position in which the frame extends substantially horizontally outwardly relative to the tray and a stowed position in which the frame extends substantially vertically relative to the tray, a load-carrying platform structure suspended from the support frame by several flexible elements, and a drive system for extending and retracting the flexible elements relative to the support frame so as to raise and lower the platform structure vertically relative to the frame between a position in which the platform structure is adjacent the tray and a position in which the platform structure is adjacent the ground, the flexible elements maintaining the platform structure in a substantially horizontal orientation during its vertical movement, wherein the opposed longitudinal frame members of the frame are displaceable into a reduced-length configuration to reduce the height of the frame when in said stowed position, and the platform structure is displaceable into a configuration of reduced depth whereby to be of reduced height when in said stowed position.

3. A lifting system according to claim 2, wherein each of the opposed longitudinal frame members is of articulated structure formed by an outer part of the frame member pivoted to an inner part of the frame member and displacement to the reduced length configuration is effected by pivoting the outer part of the frame member from an extended operative configuration in which it is aligned with the inner part of the frame member to a retracted position in which it extends substantially perpendicularly to the inner part of the frame member.

4. A lifting system according to claim 3, wherein at least some of the flexible elements pass along the longitudinal frame members and the tension in the said elements in the operative condition of the lifting system acts to maintain the outer part of the frame member in its extended operative configuration, thereby preventing unintentional pivotal movement into the retracted position.

5. A lifting system according to claim 3, wherein the platform structure comprises an outer platform segment which is able to be pivoted over an inner platform segment whereby to reduce the depth of the platform structure prior to movement into the stowed position.

6. A lifting system according to claim 5, wherein when the outer platform segment has been pivoted over the inner platform segment, the outer parts of the two longitudinal frame members are pivoted substantially through 90° inwardly to lie adjacent the transverse edges of the inner and outer platform segments.

7. A lifting system according to claim 3, further comprising a spring linked to the frame via a tension element such that when the frame is in its operative condition the spring is loaded via the tension element to apply to the frame a force acting to assist manual displacement of the frame and platform structure from the operative position into the stowed position.

8. A lifting system according to claim 7, wherein the spring is mounted within the transverse frame member and the tension element comprises a cable connected at one end to the spring and at an opposite end to a mounting fixed relative to the vehicle, said cable passing via a guide attached to one of the longitudinal frame members.

9. A pick-up truck having a load carrying tray and sidewalls extending along each longitudinal side of the tray, and a lifting system for lifting a load between the ground and the tray, said system comprising a support frame having opposed longitudinal frame members interconnected at their inner ends by a transverse frame member adapted to lie adjacent the tray whereby the frame is of generally U-shape open at an outer side, the frame being mounted for pivotal movement about a generally horizontal axis parallel to the transverse frame member such that the frame is pivotal between an operative position in which the frame extends substantially horizontally outwardly relative to the tray and a stowed position in which the frame extends substantially vertically relative to tile tray, a load-carrying platform structure suspended from the support frame by several flexible elements, and a drive system for extending and retracting the flexible elements relative to the support frame so as to raise and lower the platform structure vertically relative to the frame between a position in which the platform structure is adjacent the tray and a position in which the platform structure is adjacent the ground, the flexible elements maintaining the platform structure in a substantially horizontal orientation during its vertical movement, wherein the opposed longitudinal frame members of the frame are displaceable into a reduced-length configuration to reduce the height of the frame when in said stowed position, and the platform structure is displaceable into a configuration of reduced depth whereby to be of reduced height when in said stowed position, and wherein in said stowed position the platform structure forms a tailgate of the truck and is of a height approximating to that of the said sides of the truck.
